(19) United States
(12) Patent Application Publication
(10) Pub. No.: US 2016/0269163 A1
(43) Pub. Date: Sep. 15, 2016

(54) METHOD AND APPARATUS FOR IMPROVING RANDOM ACCESS PROCEDURE IN WIRELESS NETWORK

(71) Applicant: ALCATEL LUCENT, Boulogne-Billancourt (FR)

(72) Inventors: Shin Horng Wong, Chippenham (GB); Zhang Zhang, Shanghai (CN); Yu Chen, Shanghai (CN); Matthew Baker, Canterbury (GB)

(73) Assignee: Alcatel Lucent, Boulogne Billancourt (FR)

(21) Appl. No.: 15/033,017

(22) PCT Filed: Oct. 30, 2014
(86) PCT No.: PCT/IB2014/002614

§ 371 Date: Apr. 28, 2016

(30) Foreign Application Priority Data
Nov. 1, 2013 (CN) 201310536077.6

(51) Int. Cl. H04L 5/00; H04W 72/04

(52) U.S. Cl. CPC H04L 5/0053; H04W 72/042

(57) ABSTRACT

Embodiments of the present disclosure relate to a method and apparatus for improving random access in a wireless communication system. The method comprises: including, in the system information transmitted by a base station, information about transmission of a second message or both information about transmission of the second message and information about transmission of a fourth message; and including, in the second message transmitted by the base station, information about transmission of a third message, or both information about transmission of the third message and information about transmission of the fourth message; such that achieving a random access procedure without PDCCH scheduling, improving spectral efficiency of a UE with a poor coverage performance, and reducing implementation complexity of the system. Embodiments of the present disclosure provide a corresponding apparatus for performing the method.

### FIELD OF THE INVENTION

Embodiments of the present disclosure relate to a random access procedure of a terminal in a wireless network, and specifically to a method and apparatus for improving the random access procedure.

### BACKGROUND OF THE INVENTION

A Machine Type Communication (MTC) device is a user terminal (UE) that is used by a machine for specific application. An example of such a MTC device is a smart meter. Some of these smart meters are located in a basement, which suffer from high penetration loss and therefore it is difficult for the MTC device to communicate with the network. In view of this situation, some standardization organizations are formulating technical specifications to ensure communication of such MTC device. For example, in 3GPP a new Work Item, i.e., a Work Item of “Low Cost MTC UE Coverage Enhancement”, is approved. This study on coverage enhancement aspect aims at extending the coverage of such MTC UE (e.g., MTC UE located in the basement) by 15 dB. These UEs are referred to as Coverage Enhanced MTC UE (CE-MTC UE) herein.

It is recognized during studies on coverage enhancement, e.g., during the Study Item phase of this topic in 3GPP, that repetition is a main method for solving CE-MTC UE coverage issue. The amount of repetitions required is significant (in the 100s), which leads to significant degradation to the spectral efficiency. It is therefore more spectrally efficient to set several levels of repetitions for CE-MTC UEs at different coverage levels compared to having a single repetition level targeting the CE-MTC UE with the worst radio condition.

It should be appreciated that for the CE-MTC UE, the above method of repetition needs to be applied to a transmission procedures of various data and messages, including a random access (RACH) procedure. The random access procedure consists of the following message exchanges:

1) Preamble transmission in the uplink (Message 1)
2) Random Access Response (RAR) in the downlink (Message 2)
3) Message 3 (e.g. RRC Connection Request) in the uplink
4) Message 4 (Contention Resolution Message) in the downlink

In the current 3GPP LTE technical specification, Physical Downlink Control Channel (PDCCH) is used to indicate the resource allocation for RAR and message 4, and the UE monitors PDCCH by RA-RNTI and C-RNTI respectively to obtain resource allocation information for the RAR and Message 4, and then monitors contents of the RAR and Message 4 in the indicated resource. As PDCCH also suffers from the high penetration loss, it may also need many repetitions so that the UE can correctly detect it, which makes the current random access method of scheduling RAR and Message 4 by using PDCCH not resource-efficient.

Meanwhile, since PDCCH is also used for carrying common information which is also monitored by normal UEs (non-CE-MTC UEs), operations of the normal UEs will be affected if repetition is applied to the PDCCH carrying the common information.

Based on the above problems, it is desirable to improve the random access procedure to achieve random access without PDCCH scheduling, and thereby improve the resource efficiency.

### SUMMARY OF THE INVENTION

As stated above, the current random access method of scheduling RAR and Message 4 by using PDCCH is not resource-efficient, so if transmission of the PDCCH for scheduling can be omitted from the random access procedure, the resource efficiency may be improved and the system complexity may be reduced. However, in the current prior art there are not details about how to implement the random access procedure without PDCCH scheduling. Embodiments according to the present disclosure aim to provide a method and apparatus for improving the random access procedure to implement the random access without PDCCH scheduling and solve the problem(s) mentioned above.

According to one aspect of the present disclosure, there is provided a method for a random access procedure in a wireless communication network at a base station, the random access procedure involving a first message, a second message, a third message and a fourth message, the method comprising:

transmitting system information which comprises information about transmission of the second message or comprises both information about transmission of the second message and information about transmission of the fourth message;
receiving, from a terminal, the first message transmitted in a first wireless resource block;
transmitting the second message to the terminal in a second wireless resource block according to the information about transmission of the second message, wherein the second message comprises information about transmission of the third message, or comprises both information about transmission of the third message and information about transmission of the fourth message;
receiving, from the terminal, the third message transmitted in a third wireless resource block according to information about transmission of the third message; and
transmitting the fourth message to the terminal in a fourth wireless resource block, according to the information about transmission of the fourth message included in the system information and/or the information about transmission of the fourth message included in the second message.

In an embodiment of the method, the information about transmission of the second message included in the system information and the information about transmission of the fourth message respectively comprise a decoding candidate set of the second message and a decoding candidate set of the fourth message, and each candidate in the decoding candidate set for the second message and the decoding candidate set for the fourth message is described by at least one item of the following information:
information for indicating a size of a used physical resource;
information for indicating a location of the used physical resource, wherein location information of the physical resource comprises time and frequency information;
information for indicating a used modulation coding format;
information for indicating a number of repetitions used;
information for indicating a used scrambling code;

In another embodiment of the method, the information about transmission of the second message and/or the information about transmission of the fourth message may be included in the system information in the following manner:

defining a mapping criteria for each RACH resource included in the system information so that each RACH resource is mapped to the corresponding information about transmission of the second message, and/or mapped to the corresponding information about transmission of the fourth message.

Meanwhile, according to some embodiments of the present method, each RACH resource included in the system information is defined by one or more of the following parameters:
frequency resource;
time resource;
codeword resource for code division multiplexing; and
repetition level.

In some optional embodiments, the information about transmission of the second message and/or the information about transmission of the fourth message to which different RACH resources are mapped at least partially overlap according to the mapping criteria.

According to a further embodiment of the present method, the system information only comprises an indication of the first candidate in the decoding candidate set of the second message and/or the decoding candidate set of the fourth message, and indications of other candidates may be derived based on the indication of the first candidate according to a predetermined criteria.

According to a further embodiment, the candidates in the decoding candidate set of the second message and/or the decoding candidate set of the fourth message are indicated by a physical resource offset, wherein the physical resource offset is an offset in frequency and/or time.

In some further embodiments, the physical resource offset at least comprises one of the following offsets:
an offset relative to a RACH resource; and
an offset relative to the second wireless resource block.

In some other embodiments of the present method, an example of the information about transmission of the fourth message included in the second message is a decoding candidate set of the fourth message, and another example is an index which indicates one candidate in the decoding candidate set of the fourth message included in the system information.

In some embodiments, there is a predetermined time interval between one or more of the first message, second message, third message and fourth message and another message happening prior thereto. Furthermore, according to some embodiments, the predetermined time intervals for different messages may vary. In some other embodiments, the predetermined time interval is same for each message. According to some embodiments, the predetermined time interval is included in the system information or defined by a technical specification.

In an embodiment of the present method, the second message and/or the fourth message are transmitted in a physical downlink control channel (PDCCH), an evolved physical downlink control channel (ePDCCH) or a physical downlink shared channel (PDSCH) and wherein the second wireless resource block and the fourth wireless resource block respectively correspond to a resource block for the PDCCH, or a resource block for the ePDCCH or a resource block for the PDSCH.

According to another aspect of the present disclosure, there is provided a method for a random access procedure in a wireless communication network at an UE side, the random access procedure involving a first message, a second message, a third message and a fourth message, the method comprising:

receiving system information which comprises information about transmission of the second message or comprises both information about transmission of the second message and information about transmission of a fourth message;
transmitting the first message to the base station in a first wireless resource block;
receiving, in a second wireless resource block, the second message from a base station according to the information about transmission of the second message, wherein the second message comprises information about transmission of a third message, or comprises both information about transmission of the third message and information about transmission of the fourth message;
transmitting the third message to the base station in a third wireless resource block according to the information about transmission of the third message; and
receiving, in a fourth wireless resource block, the fourth message from the base station according to the information about transmission of the fourth message included in the system information and/or included in the second message.

Third aspect of the present disclosure relates to an apparatus for executing a random access procedure in a wireless communication network, comprising:

a first transmitting module for transmitting system information which comprises information about transmission of a second message or comprises both information about transmission of the second message and information about transmission of a fourth message;
a first receiving module for receiving a first message which is transmitted from a terminal in a first wireless resource block;
a second transmitting module for transmitting the second message to the terminal in a second wireless resource block according to the information about transmission of the second message, wherein the second message comprises information about transmission of a third message, or comprises both information about transmission of the third message and information about transmission of the fourth message;
a second receiving module for receiving the third message that is transmitted from the terminal in a third wireless resource block according to the information about transmission of the third message; and
a third transmitting module for transmitting the fourth message to the terminal in a fourth wireless resource block according to the information about transmission of the fourth message included in the system information and/or the information about transmission of the fourth message included in the second message.

The fourth aspect of the present disclosure is another apparatus for executing a random access procedure in a wireless communication network, comprising:

a first receiving module, for receiving system information which comprises information about transmission of a second message or comprises both information about transmission of the second message and information about transmission of a fourth message;
a first transmitting module, for transmitting a first message to the base station in a first wireless resource block;
a second receiving module, for receiving in a second wireless resource block the second message from the base station according to the information about transmission of the second message, wherein the second message comprises information about transmission of a third message, or comprises both information about transmission of the third message and information about transmission of the fourth message;
a second transmitting module, for transmitting the third message in a third wireless resource block according to the information about transmission of the third message; and
a third receiving module, for receiving in a fourth wireless resource block the fourth message from the base station according to the information about transmission of the fourth message included in the system information and/or the information about transmission of the fourth message included in the second message.

According to some embodiments of the present disclosure, the present disclosure can improve the random access procedure to achieve random access without PDCCH scheduling and thereby improve the resource efficiency.

### BRIEF DESCRIPTION OF DRAWINGS

Some embodiments of the method and/or apparatus according to embodiments of the present disclosure are described below only by means of examples and with reference to figures. In the figures:

FIG. 1 illustrates a schematic view of message exchanging between a terminal and a base station during a random access procedure in an embodiment according to the present disclosure;

FIG. 2a illustrates a flow chart of an exemplary method at the base station according to an embodiment;

FIG. 2b illustrates a flow chart of an exemplary method at the UE according to an embodiment;

FIG. 3 illustrates a schematic view of a time sequence corresponding to steps shown in FIG. 2a and FIG. 2b according to an embodiment;

FIG. 4 illustrates a schematic view of a RAR resource candidate set indicated in the form of an offset;

FIG. 5 illustrates a schematic view of a resource candidate set for the fourth message indicated in the form of an offset;

FIG. 6 illustrates another example of indicating a candidate resource by using an offset;

FIG. 7 illustrates a schematic view of the base station for executing the method of FIG. 2a according to an embodiment of the present disclosure; and

FIG. 8 illustrates a schematic view of the UE for executing the method of FIG. 2b according to an embodiment of the present disclosure.

### DETAILED DESCRIPTION OF PREFERRED EMBODIMENTS

Some functions or structures well known by those skilled in the art are omitted in the following description to prevent them from obscuring embodiments of the present disclosure in unnecessary details.

Embodiments of the present disclosure relate to improvements to a random access procedure in a wireless network and are intended to improve resource efficiency of terminals with poor coverage performance and reduce implementation complexity of the system.

Aspects of the present disclosure will be described with reference to non-restrictive specific examples. Those skilled in the art will understand that the present disclosure is not limited to the examples disclosed herein and it may be applied more widely. Besides, it should be appreciated that the following description of the present disclosure and its embodiments are described only for specific exemplary network configurations and deployments and mainly with reference to specific technical specification as non-restrictive examples. Specifically, the present disclosure and its embodiments mainly depict 3GPP technical specifications as non-restrictive examples for exemplary network configurations and deployments. Particularly, LTE/LTE-A communication system is used as an example of a non-restrictive communication system exploiting the exemplary examples descried herein. Hence, the depictions of exemplary examples presented herein mainly refer to technical terms in LTE/LTE-A. These technical terms are only used in the context of the non-restrictive examples presented herein and therefore are not intended to limit the present disclosure. On the contrary, any other network configurations and system deployments may be used so long as they are compatible with features mentioned herein.

In the description below, several alternative methods are used to describe various embodiments and implementation aspects of the present disclosure. It may be understood that all of these alternative solutions may be provided individually or in any possible combinations according to certain demands and limitations.

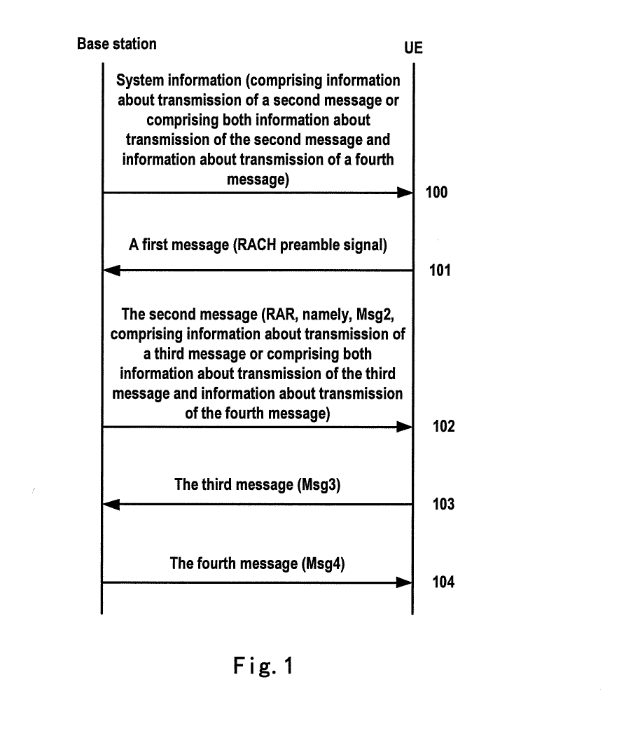

FIG. 1 illustrates a schematic view of message exchanges between a terminal and a base station during a random access procedure. It is noted that before initiating a random access procedure, an UE firstly monitors a synchronization signal (not shown in FIG. 1) from the base station to obtain downlink synchronization, and then receives broadcast signals, including system information. This procedure is shown by 100 in FIG. 1. The system information includes information about allocation of random access resource (referred to as RACH resource herein), namely, resource for transmitting a RACH preamble signal (called the first message or Message 1 herein), wherein this resource may be described with time, frequency and codewords of a preamble signal sequence. In some embodiments, the information about RACH resource allocation may further comprise a specific RACH resource indication for a MTC UE (CE-MTC UE) which needs coverage enhancement, for example, an indication of available number of repetitions or repetition level for CE-MTC UE. The information about RACH resource allocation will be used by the terminal in step 101 to determine from where a RACH preamble signal is sent and/or determine a transmission format of the RACH preamble signal.

In some other embodiments, the system information further comprises information about transmission of a second message (RAR, also called Msg2 herein), or comprises both information about transmission of the second message and information about transmission of the fourth message (also called Msg4), for example, a transmission candidate set for Msg2 and/or Msg4, which is also a decoding candidate set of Msg2 and/or Msg4 as viewed from the UE. Each candidate in the decoding candidate set of Msg2 and/or Msg4 may be indicated by one or more items of the following information:
Location of a candidate resource, including frequency and time information;
A size of the candidate resource;
A modulation coding format of a corresponding message;
Number of repetitions or repetition level of the corresponding message; and
A scrambling code of the corresponding message;

The indication information will assist the UE in reducing number of blind decoding and complexity in receiving.

In some embodiments, the decoding candidate set of the Msg2 and/or Msg4 may be indicated in an explicit way, for example, an absolute resource location is indicated in an indication format used by the resource allocation in downlink control information (DCI) in LTE PDCCH.

In some other embodiments, the decoding candidate set of Msg2 and/or Msg4 may be indicated in a manner of physical resource offset, for example, an offset of the candidate resource relative to the RACH resource is indicated. As another example, an offset relative to the RACH resource may be used to indicate the decoding candidate set of Msg2, and an offset relative to the decoding candidate set of the Msg2 may be used to indicate the decoding candidate set of Msg4. In these examples, the offset may be an offset in frequency and/or time.

In some other embodiments, when there are a plurality of decoding candidates for Msg2 and/or Msg4, only one of them is indicated, for example, only information of a first candidate in the candidate set is indicated, and information of remaining candidates may be derived through a pre-defined rule.

In further embodiments, the information about transmission of the second message and information about transmission of the fourth message included in the system information is implicitly indicated through a predetermined mapping relationship, for example, the system information only explicitly indicates RACH resource (time, frequency, codeword of a preamble signal sequence, repetition level), and meanwhile a mapping relationship is defined, so that each RACH resource corresponds to one decoding candidate set of Msg2 or corresponds to both a decoding candidate set of Msg2 and a decoding candidate set of Msg4. It should be noted that decoding candidate sets corresponding to different RACH resources may overlap, for example in extreme cases, the decoding candidate sets corresponding to different RACH resources may be completely the same, for example, all RACH resources correspond to the same decoding candidate set.

The information explicitly or implicitly indicated is used by the terminal in steps 102 and 104 respectively to facilitate determination of the transmission resource and/or transmission format and/or scrambling code of Msg2 and Msg4.

After the information about the RACH resource is detected, when needed, for example when there is uplink data to be transmitted, the terminal transmits RACH preamble signal at 101 and thereby initiates a random access procedure. The preamble signal is also called the first message herein. As described above with reference to 100, the resource (e.g., time, frequency, codeword of the preamble signal sequence, and repetition level) used for transmission of the first message is determined by the terminal according to the received system information, for example, resource is randomly selected from available RACH resources indicated by the system information for transmitting the RACH preamble signal, or in some embodiments, resource is randomly selected from RACH resources for CE-MTC UEs indicated by the system information. In some embodiments, the UE may select a suitable RACH resource according to its own measurement results and the indication of RACH resources in the system information.

After this message reaches the base station and is successfully detected, responsive to this the base station transmits the second message (RAR, also called Msg2) to the terminal at step 102. As described above with reference to 100, the resource and/or transmission format (e.g., modulation coding format, number of repetitions) used for transmission of the second message is determined according to the information about transmission of the second message included in the system information, e.g., a decoding candidate set of the second message. According to some embodiments, the scrambling code used in transmission of the second message may also be determined according to the information about transmission of the second message included in the system information. Thus, the UE may only detect the corresponding scrambling code when detecting, thereby avoiding unnecessary detection and decoding for all RAR content.

The resource used to transmit the second message (RAR) may be a physical downlink control channel (PDCCH) resource, evolved PDCCH resource or PDSCH resource. Furthermore, in this case, candidates in the decoding candidate set of the second message are PDCCH, ePDCCH and PDSCH candidate resources respectively. An advantage of using the PDCCH resource for transmission is to allow reuse of RA-RNTI and PDCCH search space. It is to be noted that although the method uses PDCCH resource, it transmits RAR other than scheduling information, so no PDSCH accompanying it will be transmitted. When the ePDCCH resource is used for transmission, its resource will be defined by an ePDCCH physical resource block set (ePDCCH PRB set), scrambling code and the like. This allows reuse of a current search space method to detect ePDCCH without need to define other search spaces for blind detection. Similarly, what is transmitted in ePDCCH in this case is not scheduling information, so there is no accompanying PDSCH transmission thereafter. When the PDSCH resource is used for transmission, it differs from ordinary PDSCH transmission in that the PDSCH does not need PDCCH scheduling.

In some embodiments, there is a predetermined time interval between transmission of the second message and transmission/reception of the first message, i.e., the base station transmits the second message after a delay of a predetermined time interval after reception of the first message, and the UE receives the second message at a proper time point according to the predetermined time interval. In some embodiments, the predetermined time interval information is defined in a standard, whereas in some other embodiments, the predetermined time interval is notified to the UE through the system information. Benefiting from the predetermined time interval, the UE may reduce number of blind detection of the second message and thereby save power.

According to some embodiments, the transmitted second information comprises information about transmission of a third message or comprises both information about transmission of the third message and information about transmission of a fourth message, for example, an indication of transmission resource and/or transmission format. According to an embodiment, the information about transmission of the fourth message may be an index value which is directed to one candidate in the decoding candidate set of the Msg4 included in the system information.

After correctly receiving the second message, the UE determines the transmission resource and/or format of the third message according to the indication in the second message, e.g., an indication about the transmission resource and/or transmission format for the third message, and transmits the third message to the base station at 103. In some embodiments, there is a predetermined time interval between transmission of the third message and transmission/reception of the second message, i.e., the UE transmits the third message after a delay of a predetermined time interval after reception of the second message, and the base station receives the third message at a proper time point according to the predetermined time interval. In some embodiments, information of the predetermined time interval is defined in a standard, whereas in some other embodiments, the predetermined time interval is notified to the UE through the system information.

In some embodiments, there is also a predetermined time interval between transmission of the third message and transmission of the fourth message, i.e., the base station transmits the fourth message to the UE at step 104 after a delay of a predetermined time interval after reception of the third message, and the UE receives the fourth message at a proper time point according to the predetermined time interval. In some embodiments, the predetermined time interval information is defined in a standard, whereas in some other embodiments, the predetermined time interval is notified to the UE through the system information. The predetermined time interval may be identical with or different from the above predetermined time interval between the first message and the second message and the above predetermined time interval between the second message and the third message.

As above stated, the resource and/or transmission format used for transmission of the fourth message may be determined according to information about transmission of Message 4 included in the system information or according to information about transmission of the fourth message included in the second message, or determined according to both information, for example, in an embodiment, the system information includes information about the decoding candidate set of the fourth message, and the second message further indicates, using an index value, which candidate of the candidate set should be used for transmission/decoding of the UE's fourth message.

After the fourth message is successfully detected, the random access procedure ends up; if the fourth message is not successfully detected, there might be subsequent HARQ retransmission procedure, and after maximum number of retransmissions are reached, the HARQ procedure fails, and the UE needs to initiate a new HARQ procedure again in a later time period.

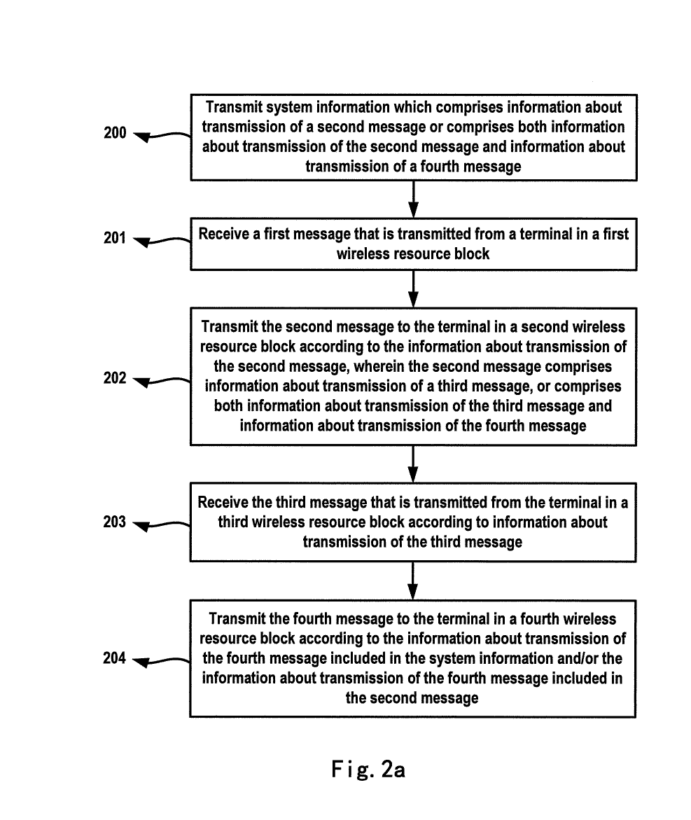

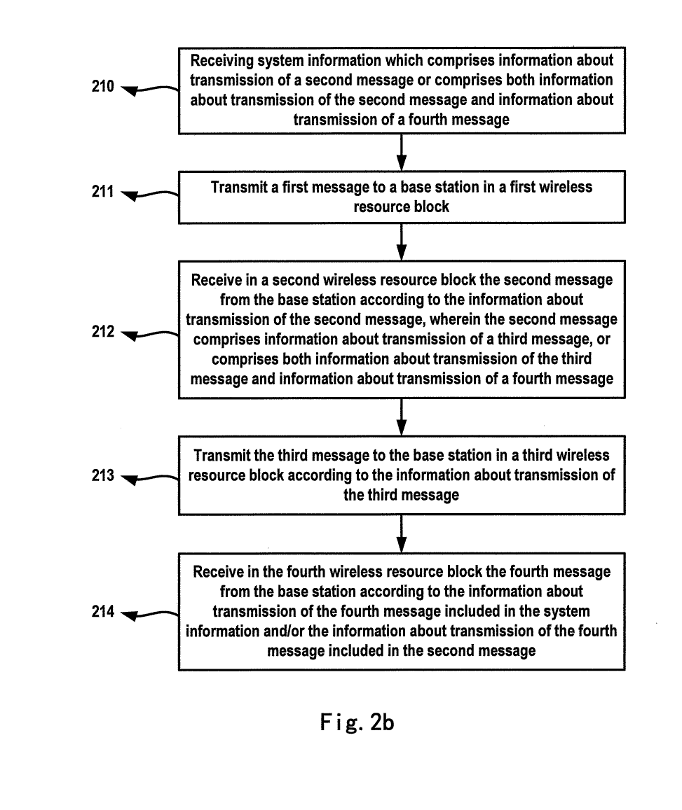

After the improved random access procedure in some embodiments of the present disclosure is summarized above with reference to FIG. 1, now reference is made to FIG. 2a and FIG. 2b which respectively depict a flowchart of an embodiment for implementing the method of the present disclosure at the base station and the UE. FIG. 2a illustrates a flow chart of an exemplary method at the base station, and FIG. 2b illustrates a flow chart of an exemplary method at the UE.

In the exemplary embodiment of FIG. 2a, the base station first transmits the system information at step 200. The system information is transmitted periodically, and the system information comprises information about transmission of a second message (RAR, called Msg2 herein), or comprises both information about transmission of the second message and information about transmission of a fourth message (also called Msg4), for example, a transmission candidate set for Msg2 and/or Msg4, which is also a decoding candidate set of Msg2 and/or Msg4 as viewed from the UE. Each candidate in the decoding candidate set of Msg2 and/or Msg4 may be indicated by one or more items of the following information:
Location of a candidate resource, including frequency and time information;
A size of the candidate resource;
A modulation coding format of a corresponding message;
Number of repetitions or repetition level of the corresponding message; and
A scrambling code of the corresponding message;

As stated in the depictions of FIG. 1, the information about transmission of the second message and information about transmission of the fourth message may be indicated in an explicit or implicit way. An example of the explicit indication is indicating an absolute resource location using an indication format used by the resource allocation in downlink control information (DCI) in LTE PDCCH. In some other embodiments, the decoding candidate set of Msg2 and/or Msg4 may be indicated in manner of a physical resource offset, for example, an offset of the candidate resource relative to the RACH resource is indicated. As another example, an offset relative to the RACH resource may be used to indicate the decoding candidate set of Msg2, and an offset relative to the decoding candidate set of the Msg2 may be used to indicate the decoding candidate set of Msg4. In these examples, the offset may be an offset in frequency and/or time.

In some other embodiments, when there are a plurality of decoding candidates for Msg2 and/or Msg4, only one of them is indicated, for example, only information of a first candidate in the candidate set is indicated, while information of remaining candidates may be obtained through a pre-defined rule.

In further embodiments, an example of implicitly indicating the information about transmission of the second message and information about transmission of the fourth message included in the system information is that, for example, the system information only explicitly indicates RACH resource (time, frequency, codeword of a preamble signal sequence, repetition level), and meanwhile a mapping relationship is defined, so that each RACH resource corresponds to one decoding candidate set of Msg2 or corresponds to both one decoding candidate set of Msg2 and one decoding candidate set of Msg4. It should be noted that decoding candidate sets corresponding to different RACH resources may overlap, for example in an extreme case, the decoding candidate sets corresponding to different RACH resources may be completely the same, for example, all RACH resources correspond to the same decoding candidate set.

Thereafter, at step 201 the base station detects the first message from the terminal, the first message corresponds to the RACH preamble signal in LTE. The wireless resource for detecting the first message is designated by information about RACH resource included in the system information. The information about the RACH resource may be an indication of time, frequency, codeword of a preamble signal sequence or the like. In some embodiments, the information about the RACH resource may further comprise an indication of a specific RACH resource for MTC UEs which require coverage enhancement (i.e., CE-MTC UE), for example, an indication of available number of repetitions or repletion level for CE-MTC UE. Based on the information about RACH resource, the base station determines where to receive the RACH preamble signal and/or determines the transmission format of the RACH preamble signal. If there are many kinds of RACH resources and transmission formats designated in the system information, the base station will blind-detect possible RACH formats on respective possible resources, and detects the first message at the first wireless resource.

According to this embodiment, after reception of the first message, delaying for a predetermined time interval t1, the base station performs step 202, i.e., sends the second message (RAR) to the UE. The second message is performed on the a second wireless resource. As described above with reference to step 200, the second wireless resource may be explicitly or implicitly indicated by the system information. Examples of explicit or implicit indication have already been presented in the depictions about step 200 and thus will not be detailed any longer here.

The transmitted second information comprises information about transmission of the third message or comprises both information about transmission of the third message and information about transmission of the fourth message, for example, an indication of transmission resource and/or transmission format. According to an embodiment, information about transmission of the fourth message may be an index value which is directed to one candidate in the decoding candidate set of the Msg4 included in the system information.

After sending the second message, the base station, after delaying for a predetermined time interval t2, receives at step 203 the third message (corresponding to Message 3 in LTE, or denoted as Msg3) from the UE. The third message is received at a third wireless resource, which is designated by the information about transmission of the third message in the second message.

Similarly, after receiving the third message, the base station, after delaying for a predetermined time interval t3, transmits the fourth message (corresponding to Message 4 in LTE, or denoted as Msg4) to the UE at step 204. The fourth message is performed on a fourth wireless resource. As described above with reference to step 200, the transmission format of the fourth wireless resource and/or fourth message may be explicitly or implicitly indicated by the system information. Examples of explicit or implicit indication have already been presented in the depictions about step 200 and will not be detailed any longer here.

FIG. 2b illustrates a flow chart of a corresponding exemplary method at the UE side. In the exemplary embodiment of FIG. 2b, the UE first receives the system information at step 210. The system information is transmitted periodically, and the system information comprises information about transmission of a second message (RAR, called Msg2 herein), or comprises both information about transmission of the second message and information about transmission of a fourth message (also called Msg4), for example, a transmission candidate set for Msg2 and/or Msg4, which is also a decoding candidate set of Msg2 and/or Msg4 as viewed from the UE. Each candidate in the decoding candidate set of Msg2 and/or Msg4 may be indicated by one or more items of the following information:
Location of a candidate resource, including frequency and time information;
A size of the candidate resource;
A modulation coding format of a corresponding message;
Number of repetitions or repetition level of the corresponding message; and
A scrambling code of the corresponding message;

As stated in the depictions of FIG. 1, the information about transmission of the second message and information about transmission of the fourth message may be indicated in an explicit or implicit way. An example of the explicit indication is indicating an absolute resource location using an indication format used by the resource allocation in downlink control information (DCI) in LTE PDCCH. In some other embodiments, the decoding candidate set of Msg2 and/or Msg4 may be indicated in a manner of physical resource offset, for example, an offset of the candidate resource relative to the RACH resource is indicated. As another example, an offset relative to the RACH resource may be used to indicate the decoding candidate set of Msg2, and an offset relative to the decoding candidate set of the Msg2 may be used to indicate the decoding candidate set of Msg4. In these examples, the offset may be an offset in frequency and/or time.

In some other embodiments, when there are a plurality of decoding candidates of Msg2 and/or Msg4, only one of them is indicated, for example, only information of a first candidate in the candidate set is indicated, while information of remaining candidates may be obtained through a pre-defined rule.

In further embodiments, an example of implicitly indicating the information about transmission of the second message and information about transmission of the fourth message included in the system information is that, for example, the system information only explicitly indicates RACH resource (time, frequency, codeword of a preamble signal sequence, repetition level), and meanwhile a mapping relationship is defined, so that each RACH resource corresponds to a decoding candidate set of Msg2 or corresponds to both a decoding candidate set of Msg2 and a decoding candidate set of Msg4. It should be noted that decoding candidate sets corresponding to different RACH resources may overlap, for example in extreme cases, the decoding candidate sets corresponding to different RACH resources may be completely the same, for example, all RACH resources correspond to the same decoding candidate set.

Thereafter, at step 211 the UE sends the first message to the base station, and the wireless resource for sending the first message is designated by information about RACH resource included in the system information. The information about the RACH resource may be an indication of time, frequency, codeword of a preamble signal sequence or the like. In some embodiments, the information about the RACH resource may further comprise a specific RACH resource indication for MTC UEs which require coverage enhancement (CE-MTC UEs), for example, an indication of available number of repetitions or repletion level for CE-MTC UE. Based on the information about RACH resource, the UE determines from where the RACH preamble signal is to be sent and/or determines the transmission format of the RACH preamble signal. If there are many kinds of RACH resources and transmission formats specified in the system information, the UE will randomly select from a plurality of RACH resources, or select a suitable RACH resource therefrom based on measurement and/or a selection criterion.

According to this embodiment, after reception of the first message, delaying for a predetermined time interval t1, the UE performs step 212, i.e., receives the second message (RAR) from the base station. The second message is detected on a second wireless resource. As described above with reference to step 210, the second wireless resource may be explicitly or implicitly indicated by the system information. Examples of explicit or implicit indication have already been presented in the depictions about step 210 and will not be detailed any longer.

The received second information comprises information about transmission of the third message or comprises both information about transmission of the third message and information about transmission of the fourth message, for example, an indication of transmission resource and/or transmission format. According to an embodiment, information about transmission of the fourth message therein may be an index value which is directed to a candidate in the decoding candidate set of the Msg4 included in the system information.

After receiving the second message, the UE, after delaying for a predetermined time interval t2, sends the third message to the base station at step 213. The third message is sent at a third wireless resource, and the third wireless resource is designated by the information about transmission of the third message in the second message.

Similarly, after sending the third message, the UE receives the fourth message from the base station at step 214 after a delay of a predetermined time interval t3. The fourth message is detected on a fourth wireless resource. As described above with reference to step 210, the fourth wireless resource and/or the transmission format of the fourth message may be explicitly or implicitly indicated by the system information. Examples of explicit or implicit indication have already been presented in the depictions about step 200 and will not be detailed any longer.

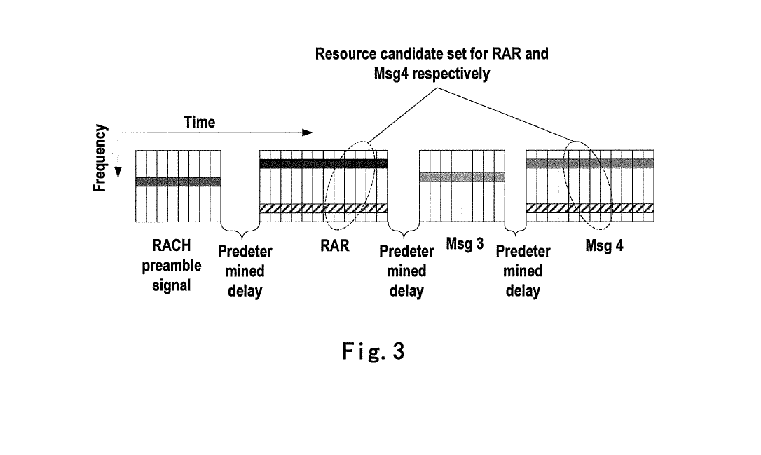

It should be noted that the predetermine time intervals t1, t2, t3, t4 in FIG. 2a respectively equal the predetermined time intervals t1, t2, t3, t4 in FIG. 2b, but any two of t1, t2, t3 and t4 might be identical or different. The predetermined time intervals t1, t2, t3 and t4 may be specified in a standard/technical specification, or notified to the UE by the base station in the system information. FIG. 3 illustrates a schematic view of a time sequence corresponding to steps shown in FIG. 2a and FIG. 2b according to an embodiment, wherein examples of the predetermined time intervals t1, t2, t3 and t4 are shown. In the embodiment of FIG. 3, after the first message (preamble signal) is sent, the second message is sent after a delay of the time interval t1, and the resource used by the second message is selected from the wireless resource (PRB) candidate set for RAR. The wireless resource (PRB) candidate set for RAR is included in the system information. After the second message is sent, the third message (Message 3) is sent after a delay of the time interval t2. Similarly, after the third message is sent, the fourth message (Message 4) is sent after a delay of the time interval t3, and the resource used by the fourth message is selected from the wireless resource (PRB) candidate set of the fourth message. The wireless resource (PRB) candidate set of the fourth message is included in the system information or included in the second message.

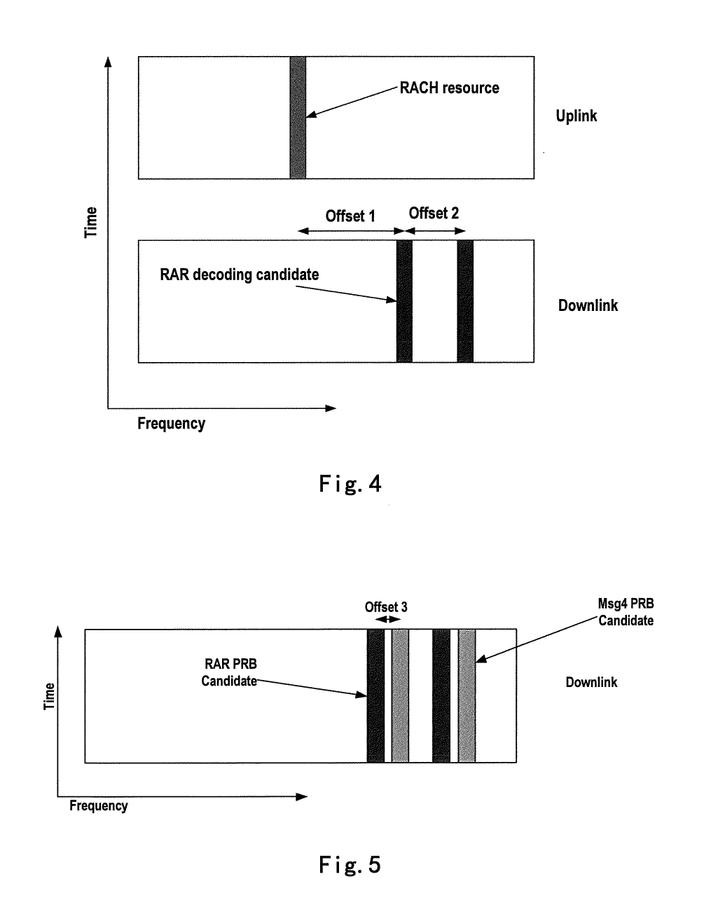

As an example, FIG. 4 illustrates a schematic view of a RAR wireless resource candidate set indicated in the form of an offset. In this example, the RAR wireless resource candidate set includes two candidate resources which are indicated by an offset 1 (offset1) relative to the RACH resource and an offset 2 (offset2) relative to the first candidate resource, respectively. In some embodiments, the indication may be performed with only one offset, for example, only offset 1 is used to indicate the first candidate resource, and the second candidate resource is obtained according to a predetermined rule, for example, a rule is set in a way that offset2=offset1, or in a way that offset2 equals to a fixed value.

As another example, FIG. 5 illustrates a schematic view of a wireless resource candidate set for the fourth message indicated in the form of an offset. In this example, the wireless resource candidate set for the fourth message is indicated by an offset 3 (offset3) which is an offset relative to the RAR candidate resource. Therefore, the candidate resource for the fourth message may be determined based on the indication about the RAR candidate resource and the offset 3. It should be appreciated that this is only an exemplary embodiment, and in other embodiments, the offset for indicating the candidate resource of the fourth message may also be the offset relative to the RACH resource.

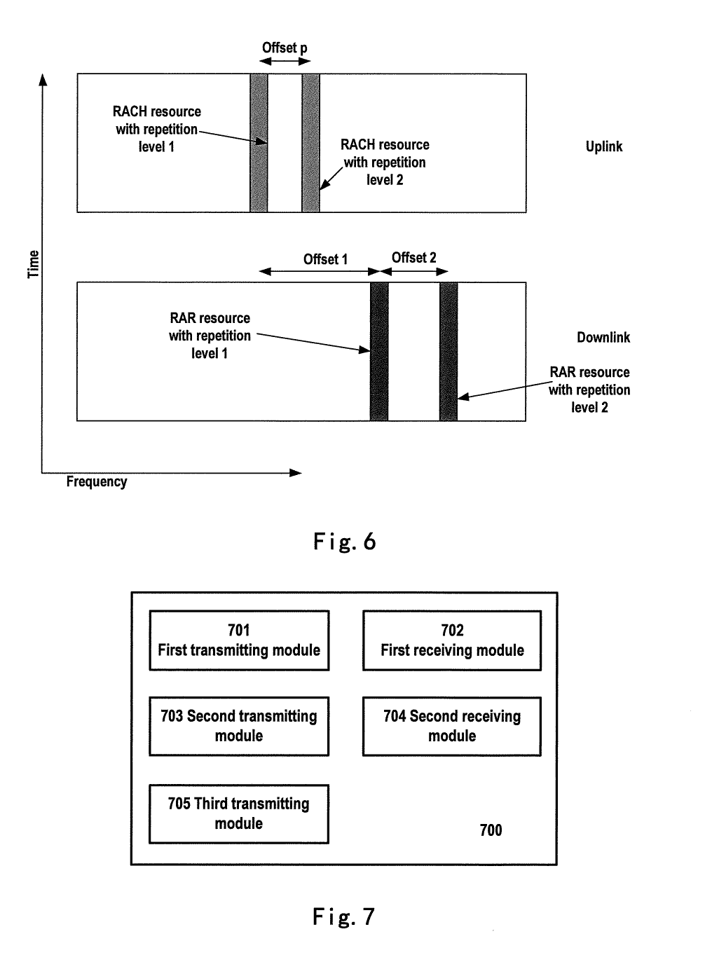

FIG. 6 illustrates another example of indicating a candidate resource by using an offset. In this example, the offset depends on a repetition level of the RACH. For example, if the transmission of the first message, namely, the transmission of the RACH preamble signal, employs a first level of repetition, the candidate resource of the RAR may be determined by using an offset 1 relative to the RACH resource; if the transmission of the first message, namely, the transmission of the RACH preamble signal, employs a second level of repetition, the candidate resource of RAR may be determined by using a result of addition of the offset 1 relative to the RACH resource and another offset p (offset-p).

FIG. 7 illustrates a schematic view of a base station 700 for executing the method of FIG. 2a according to an embodiment of the present disclosure. As shown in the figure, the base station in this embodiment at least comprises the following modules:

A first transmitting module 701 for transmitting system information which comprises information about transmission of a second message or comprises both information about transmission of the second message and information about transmission of a fourth message;

A first receiving module 702 for receiving a first message transmitted from the terminal in a first wireless resource block;

A second transmitting module 703 for transmitting the second message to the terminal in a second wireless resource block according to the information about transmission of the second message, wherein the second message comprises information about transmission of a third message, or comprises both information about transmission of the third message and information about transmission of the fourth message;

A second receiving module 704 for receiving the third message that is transmitted from the terminal in a third wireless resource block according to information about transmission of the third message; and

A third transmitting module 705 for transmitting the fourth message to the terminal in a fourth wireless resource block according to the information about transmission of the fourth message included in the system information and/or the information about transmission of the fourth message included in the second message.

In some embodiments of the apparatus of the present disclosure, the information about transmission of the second message and transmission of the fourth message in the system information may be indicated in an explicit way (e.g., absolute resource and/or transmission format indication) or in an implicit way (e.g., a predefined mapping with the RACH resource/transmission format). Examples of explicit indication or implicit indication are presented in the depictions of FIGS. 2a-2b and will not be detailed here anymore. The content of the information about transmission of the second message and fourth message may be candidate sets for transmission of the second message and fourth message respectively. Each candidate in the candidate set may be indicated by one or more items of the following information:
Location of a candidate resource, including frequency and time information;
A size of the candidate resource;
A modulation coding format of a corresponding message;
Number of repetitions or repetition level of the corresponding message; and
A scrambling code of the corresponding message;

In some embodiments of the apparatus of the present disclosure, the first wireless resource for receiving the first message is designated by the information about RACH resource included in the system information. For example, the resource (time, frequency, codeword, number of repetitions or repetition level) that can be used by the CE-MTC UEs for RACH may be indicated in the system information, and a corresponding RACH transmission format (e.g., number of repetitions) may be explicitly or implicitly designated for different RACH physical resources (time, frequency, codeword). If there are a plurality of RACH resources designated in the system information, the first receiving module 702 can firstly determine possible RACH physical resources and transmission formats according to the system information, and then blind-detects possible RACH formats on respective possible physical resources.

In some embodiments of the apparatus of the present disclosure, the second transmitting module 703 determines a transmission time of the second message according to a predetermined time interval t1, and determines, according to the information about transmission of the second message in the system information, the second wireless resource and a certain transmission format for transmission of the second message, and transmits the second message. As described above, the information about transmission of the second message in the system information may be explicitly or implicitly indicated. Examples of explicit or implicit indication have already been presented in the depictions of FIGS. 2a and 2b and will not be detailed any longer.

In some embodiments of the apparatus of the present disclosure, the second receiving module 704 in the apparatus determines a receiving time of the third message according to a predetermined time interval t2, and determines, according to the information about transmission of the third message in the second message, the third wireless resource and a certain transmission format for reception and detection of the third message, and receives the third message.

In some embodiments of the apparatus of the present disclosure, the third transmitting module 705 in the apparatus determines a transmission time of the fourth message according to the predetermined time interval t3, and determines, according to the information about transmission of the fourth message in the system information and/or information about transmission of the fourth message in the second message, the fourth wireless resource and a certain transmission format for transmission of the fourth message, and transmits the fourth message. As in the above depictions, the information about transmission of the fourth message in the system information may be explicitly or implicitly indicated. Examples of explicit or implicit indication have already been presented in the depictions of FIGS. 2a and 2b and will not be detailed any longer.

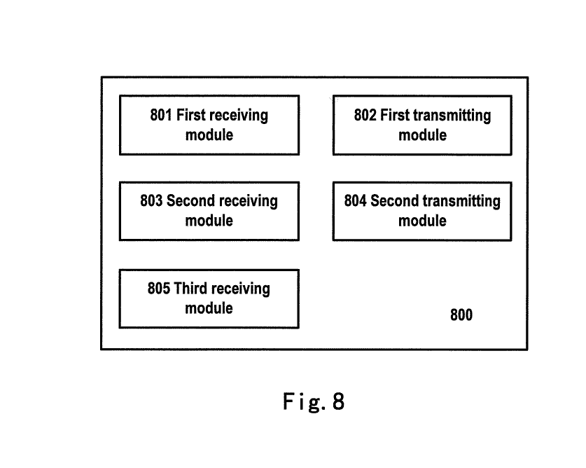

FIG. 8 illustrates a schematic view of UE 800 for executing the method of FIG. 2b according to an embodiment of the present disclosure. As shown in the figure, the UE 800 in the embodiment at least comprises the following modules:

A first receiving module 801 for receiving system information which comprises information about transmission of a second message or comprises both information about transmission of the second message and information about transmission of a fourth message;

A first transmitting module 802 for transmitting a first message to the base station in a first wireless resource block;

A second receiving module 803 for receiving in a second wireless resource block the second message from the base station according to the information about transmission of the second message, wherein the second message comprises information about transmission of a third message, or comprises both information about transmission of the third message and information about transmission of the fourth message;

A second transmitting module 804 for transmitting the third message in a third wireless resource block according to the information about transmission of the third message; and

A third receiving module 805 for receiving in a fourth wireless resource block the fourth message from the base station according to the information about transmission of the fourth message included in the system information and/or the information about transmission of the fourth message included in the second message.

In some embodiments of the apparatus of the present disclosure, the information about transmission of the second message and the fourth message in the system information may be indicated in an explicit way (e.g., indication of absolute resource and/or transmission format) or in an implicit way (e.g., a predefined mapping with the RACH resource/transmission format). Examples of explicit indication or implicit indication are presented in the depictions of FIGS. 2a-2b and will not be detailed here anymore. The content of the information about transmission of the second message and fourth message may be candidate sets for transmission of the second message and fourth message respectively. Each candidate in the candidate set may be indicated by one or more items of the following information:
Location of a candidate resource, including frequency and time information;
A size of the candidate resource;
A modulation coding format of a corresponding message;
Number of repetitions or repetition level of the corresponding message; and
A scrambling code of the corresponding message;

In some embodiments of the apparatus of the present disclosure, the first wireless resource for receiving the first message is designated by the information about RACH resource included in the system information. For example, the resource (time, frequency, codeword, number of repetitions or repetition level) that can be used by CE-MTC UE for RACH may be indicated in the system information, and a corresponding RACH transmission format (e.g., number of repetitions) may be explicitly or implicitly designated for different RACH physical resources (time, frequency, codeword). If there are a plurality of RACH resources designated in the system information, the first transmitting module 802 can firstly determine possible RACH physical resources and transmission formats according to the system information, and then randomly select one from the possible resources or select one RACH resource according to UE's measurements and/a certain selection rule.

In some embodiments of the apparatus of the present disclosure, the second receiving module 803 determines a transmission time of the second message according to a predetermined time interval t1, and determines, according to the information about transmission of the second message in the system information, the second wireless resource and a certain transmission format for detection of the second message, and receives and detects the second message. As in the above depictions, the information about transmission of the second message in the system information may be explicitly or implicitly indicated. Examples of explicit or implicit indication have already been presented in the depictions of FIGS. 2a and 2b and will not be detailed any longer.

In some embodiments of the apparatus of the present disclosure, the second transmitting module 804 in the apparatus determines a transmission time of the third message according to a predetermined time interval t2, and determines, according to the information about transmission of the third message in the second message, the third wireless resource and a certain transmission format for transmission of the third message, and transmits the third message.

In some embodiments of the apparatus of the present disclosure, the third receiving module 805 determines a transmission time of the fourth message according to the predetermined time interval t3, and determines, according to the information about transmission of the fourth message in the system information and/or information about transmission of the fourth message in the second message, the fourth wireless resource and a certain transmission format for reception of the fourth message, and receives the fourth message. As in the above depictions, the information about transmission of the fourth message in the system information may be explicitly or implicitly indicated. Examples of explicit or implicit indication have already been presented in the depictions of FIGS. 2a and 2b and will not be detailed any longer.

Additionally, it is noticeable that the exemplary block diagrams of FIG. 7 and FIG. 8 only show functional modules closely related to the present disclosure, and besides these modules, the UE and base station may comprise other modules. Furthermore, the examples show the modules individually, but in fact, as can be appreciated by those skilled in the art, several or all of these modules may be implemented by the same hardware or software or firmware or a combination thereof in specific embodiments. The function of one module in FIG. 7 may be performed by several individual modules in some other embodiments.

As can be appreciated by those skilled in the art, the modules in FIG. 7 and FIG. 8 may be implemented in a manner of hardware, software, firmware or a combination thereof, for example, the apparatus of the present disclosure may comprise a processor and a memory, wherein the memory is used to store instructions executed by the processor so that the processor is caused to complete operations of steps in FIG. 2a or FIG. 2b, or execute the functions of modules in FIGS. 7-8. Since these implementation methods via hardware, software, firmware or a combination thereof are readily envisagable for those skilled in the art, they are not listed exhaustively herein.

In addition, the description and figures only illustrate principles of the present disclosure by way of examples. Hence, it is appreciated that those skilled in the art can design various arrangements that are not explicitly described or illustrated herein, but reflect the principles of the present disclosure and are included in the spirit and scope of the present disclosure. Besides, all examples disclosed herein are mainly expressly intended for illustration purpose only to assist a reader in understanding the principles of the present disclosure and the inventor's contribution to development of concepts of the field, and will be construed as not limited to such specifically-disclosed examples and conditions. In addition, all statements here disclosing the principles, aspects and embodiments and their specific examples are intended to cover their equivalents.

1. A method for a random access procedure in a wireless communication network, comprising:
transmitting system information which comprises information about transmission of a second message or comprises both information about transmission of the second message and information about transmission of a fourth message;
receiving a first message that is transmitted from a terminal in a first wireless resource block;
transmitting the second message to the terminal in a second wireless resource block according to the information about transmission of the second message, wherein the second message comprises information about transmission of a third message, or comprises both information about transmission of the third message and information about transmission of the fourth message;
receiving the third message that is transmitted from the terminal in a third wireless resource block according to information about transmission of the third message; and
transmitting the fourth message to the terminal in a fourth wireless resource block according to the information about transmission of the fourth message included in the system information and/or the information about transmission of the fourth message included in the second message.

2. The method according to claim 1, wherein the information about transmission of the second message and the information about transmission of the fourth message included in the system information comprise a decoding candidate set of the second message and a decoding candidate set of the fourth message, respectively, and each candidate in the decoding candidate set of the second message and the decoding candidate set of the fourth message is described by at least one item of the following information:
information for indicating a size of a used physical resource;
information for indicating a location of the used physical resource, wherein the location information of the physical resource comprises time and frequency information;
information for indicating a used modulation coding format;
information for indicating number of repetitions used; and
information for indicating a used scrambling code.

3. The method according to claim 1, wherein the information about transmission of the second message and/or the information about transmission of the fourth message are included in the system information by:
defining a mapping criteria for each RACH resource included in the system information so that each RACH resource is mapped to corresponding information about transmission of the second message, and/or mapped to corresponding information about transmission of the fourth message wherein each RACH resource included in the system information is defined by one or more of the following parameters:
time resource;
codeword resource for code division multiplexing; and
repetition level.

4. (canceled)

5. (canceled)

6. The method according to claim 2, wherein the system information only comprises an indication of a first candidate in the decoding candidate set of the second message and/or the decoding candidate set of the fourth message.

7. The method according to claim 2, wherein a candidate in the decoding candidate set of the second message and/or the decoding candidate set of the fourth message is indicated by a physical resource offset, wherein the physical resource offset is an offset in frequency and/or time, wherein the physical resource offset at least comprises one of the following offsets:
an offset relative to the RACH resource;
an offset relative to the decoding candidate set of the second message; and
an offset relative to the second wireless resource block.

8. (canceled)

9. The method according to claim 2, wherein the information about transmission of the fourth message included in the second message comprises a decoding candidate set of the fourth message, or comprises an index which indicates a candidate in the decoding candidate set of the fourth message included in the system information.

10. The method according to claim 1, wherein, there is a predetermined time interval between one or more of the first message, second message, third message and fourth message and another message happening prior thereto.

11. (canceled)

12. The method according to claim 1, wherein the second message and/or the fourth message are transmitted in a physical downlink control channel (PDCCH), and the second wireless resource block and/or the fourth wireless resource block correspond to a PDCCH resource block; or
the second message and/or the fourth message are transmitted in an evolved physical downlink control channel (ePDCCH), and the second wireless resource block and/or the fourth wireless resource block correspond to an ePDCCH resource block; or
the second message and/or the fourth message are transmitted in a physical downlink shared channel (PDSCH), and the second wireless resource block and/or the fourth wireless resource block correspond to a PDSCH resource block.

13. A method for a random access procedure in a wireless communication network, comprising:
receiving system information which comprises information about transmission of a second message or comprises both information about transmission of the second message and information about transmission of a fourth message;
transmitting a first message to a base station in a first wireless resource block;
receiving in a second wireless resource block the second message from the base station according to the information about transmission of the second message, wherein the second message comprises information about transmission of a third message, or comprises both information about transmission of the third message and information about transmission of a fourth message;
transmitting the third message to the base station in a third wireless resource block according to the information about transmission of the third message; and
receiving in a fourth wireless resource block the first fourth message from the base station according to the information about transmission of the fourth message included in the system information and/or the information about transmission of the fourth message included in the second message.

14. The method according to claim 13, wherein the information about transmission of the second message and the information about transmission of the fourth message included in the system information comprise a decoding candidate set of the second message and a decoding candidate set of the fourth message, respectively, and each candidate in the decoding candidate set of the second message and the decoding candidate set of the fourth message is described by at least one item of the following information:
information for indicating a size of a used physical resource;
information for indicating a location of the used physical resource, wherein the location information of the physical resource comprises time and frequency information;
information for indicating a used modulation coding format;
information for indicating number of repetitions used; and
information for indicating a used scrambling code.

15. The method according to claim 13, wherein the information about transmission of the second message and/or the information about transmission of the fourth message are included in the system information by:
defining a mapping criteria for each RACH resource included in the system information so that each RACH resource is mapped to corresponding information about transmission of the second message, and/or mapped to corresponding information about transmission of the fourth message, wherein each RACH resource included in the system information is defined by one or more of the following parameters:
frequency resource;
time resource;
codeword resource for code division multiplexing; and
repetition level.

16. (canceled)

17. (canceled)

18. The method according to claim 14, wherein the system information only comprises an indication of a first candidate in the decoding candidate set of the second message and/or the decoding candidate set of the fourth message.

19. The method according to claim 14, wherein a candidate in the decoding candidate set of the second message and/or the decoding candidate set of the fourth message is indicated by a physical resource offset, wherein the physical resource offset is an offset in frequency and/or time, wherein the physical resource offset at least comprises one of the following offsets:
an offset relative to the RACH resource;
an offset relative to the decoding candidate set of the second message; and
an offset relative to the second wireless resource block.

20.-24. (canceled)

25. An apparatus for performing a random access procedure in a wireless communication network, comprising:
a first transmitting module for transmitting system information which comprises information about transmission of a second message or comprises both information about transmission of the second message and information about transmission of a fourth message;
a first receiving module for receiving a first message that is transmitted from a terminal in a first wireless resource block;
a second transmitting module for transmitting the second message to the terminal in a second wireless resource block according to the information about transmission of the second message, wherein the second message comprises information about transmission of a third message, or comprises both information about transmission of a third message and information about transmission of the fourth message;
a second receiving module for receiving the third message that is transmitted from the terminal in a third wireless resource block according to the information about transmission of the third message; and
a third transmitting module for transmitting the fourth message to the terminal in a fourth wireless resource block according to the information about transmission of the fourth message included in the system information and/or the information about transmission of the fourth message included in the second message.

26.-36. (canceled)

37. An apparatus for performing a random access procedure in a wireless communication network, comprising:
a first receiving module, for receiving system information which comprises information about transmission of a second message or comprises both information about transmission of the second message and information about transmission of a fourth message;
a first transmitting module, for transmitting a first message to the base station in a first wireless resource block;
a second receiving module, for receiving in a second wireless resource block the second message from the base station according to the information about transmission of the second message, wherein the second message comprises information about transmission of a third message, or comprises both information about transmission of the third message and information about transmission of the fourth message;
a second transmitting module, for transmitting the third message in a third wireless resource block according to the information about transmission of the third message; and
a third receiving module, for receiving in a fourth wireless resource block the fourth message from the base station according to the information about transmission of the fourth message included in the system information and/or the information about transmission of the fourth message included in the second message.

38.-48. (canceled)
